(19) United States
(12) Patent Application Publication
(10) Pub. No.: US 2003/0115217 A1
(43) Pub. Date: Jun. 19, 2003

(54) System and method for processing edits for a file

(76) Inventor: John R. Klug, Evergreen, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/021,999

(22) Filed: Dec. 14, 2001

(51) Int. Cl. G06F 12/00

(52) U.S. Cl. 707/200

(57) ABSTRACT

The user of any of a plurality of personal computers linked over an analog or digital network is able to edit a file in one of the personal computers. This one personal computer is a personal computer capable of multi-tasking which effectively permits multi-user access to the file. The host personal computer effectively performs polling of the remote personal computers for input to be added to the file or functions to be performed on the file. In the analog configuration, the personal computers use high-speed modems and data compression/decompression techniques.

### CROSS-REFERENCES TO RELATED APPLICATION

The present application is a continuation which is being filed contemporaneously with the continuation application identified as attorney docket no. 5814.04, Express Mail Label EV016645658US, and claims priority to co-pending nonprovisional application Ser. No. 09/139,194, filed on Aug. 25, 1998, (the '194 application), allowed. The '194 application claims priority to nonprovisional application Ser. No. 07/975,905, filed on Nov. 12, 1992, which issued on Aug. 25, 1998 and is now U.S. Pat. No. 5,799,320; (the '320 patent). The '320 patent claims priority to nonprovisional application Ser. No. 07/397,996, filed on Aug. 23, 1989, (the '996 application), now abandoned. The contents of each of which are incorporated by reference herein, in their entirety.

### BACKGROUND OF INVENTION

1. Field of the Invention

The present invention relates to a system and method which allows any one of a plurality of users to interactively edit, in real time, a given graphics and/or text/data file. More particularly, the present invention relates to a system and method which permit any or all of a plurality of users at remotely located personal computers to edit a file resident in one of the computers.

2. Description of the Related Art

For hundreds of years, authors have had to rely on highly skilled craftsmen to convert their hand-written or type-written manuscripts and artistic renderings into typeset galleys and artwork suitable for reproduction by printing. Yet, most recently, centuries of skill and tradition have been overturned by a new development in the computer industry called desktop publishing.

Desktop publishing has become possible due to the ever increasing power of personal computers, new and affordable output devices such as laser printers, and more powerful software, including page description languages, such as Postscript. Desktop publishing can now allow an individual or business to quickly and inexpensively produce attractive and professional newsletters, brochures, reports, advertisements, etc., using a single personal computer workstation.

It follows that, since expensive typesetting and printing equipment is no longer necessary to produce professional looking printed products, an entire new industry has opened up for small graphics and publishing businesses to produce affordable, custom-tailored, professional-looking, printed products for a wide variety of individual and corporate clients. An example of one such industry where desktop publishing has opened significant new opportunities is the production of periodic publications, e.g. the newsletter industry.

Newsletters are periodical publications which contain news or information, usually of a timely nature, which is of interest to a specific group of people. Businesses often use newsletters for promotional purposes and/or to keep in touch with existing clients, or to motivate and/or inform their own employees.

Frequently, rather than produce a newsletter itself, a business will contract with a specialized outside newsletter publisher to write, edit, typeset copy, produce final art, and print the completed newsletter. In this case, the newsletter publisher will most likely provide a basic graphic format for the newsletter, and will also be in possession of particular articles which will be of interest to a variety of readers. For example, an article providing financial advice would be suitable for newsletters that several different banks might wish to provide to their clients. An article designed to motivate employees would be suitable for newsletters that many different companies may wish to provide to their own employees.

It is critical to note, however, that in almost all cases the graphics and editorial content of each corporate customer's newsletter must be custom tailored to that individual corporate customer. And while the actual production of the newsletter has been made more economical with the development of desktop publishing, a major new problem has emerged, which is how to perform effective editing of the newsletter in a timely fashion when the publisher and the customer are remotely located. Obviously, it is imperative that the customer be happy with the final product, and yet, the time required for the interactive editing process cannot be so lengthy as to cause the information contained in the newsletter to become stale.

The problem of timing and coordination of this editing process becomes exponentially acute when, as is often the case, more than two approval entities are involved at different locations. For example, at a client bank the newsletter publisher may need to coordinate and get input/approvals from three or more separate departments such as marketing, legal and branch administration. Or, another example is the client may be at one location, say Kansas City. The newsletter firm is in Denver and the client's advertising agency, which is also involved in the project, is in San Francisco.

One method for the remote editing of a newsletter at one or more remote locations has been for the newsletter publisher to actually send a computer diskette having the newsletter stored thereon by mail to its customer. The customer then reviews the newsletter on its own personal computer and makes any desired changes. However, this method requires a relatively sophisticated customer, and can be time consuming, especially if more than two mailings of the diskette is necessary. Inevitably, information in the newsletter may become stale, and deadlines for periodical newsletters—particularly weekly and monthly newsletters—become difficult to meet.

A second method for the remote editing of a newsletter has been performed utilizing dedicated facsimile machines, and/or PCs which are capable of sending and receiving facsimiles through software, added hardware and modems. According to this method, the newsletter publisher sends a hard copy version of the newsletter to the customer via its facsimile machine. The customer then indicates any desired changes on the proposed newsletter, and sends a copy of the edited newsletter back to the newsletter publisher by facsimile. This editing method, too, can take several exchanges, given the uneven quality of transmission, misinterpretation of editing notes, and normal office delays in routing, actually reviewing, and forwarding documents, until the newsletter meets the customer's approval.

A third method has been the use of telephone conversations with the customer, and via a conference call if more than two parties are involved. This by itself is the weakest of the three methods. As each person does not actually see the newsletter, misunderstandings are bound to occur, resulting in a dissatisfied customer. Using telephone conversations to augment the first two methods is an improvement, but each person may not have the latest version of the newsletter before them, and it is not a cure-all.

The inventor of the present invention believes the most desirable editing method is for all parties involved with both the customer and the publisher to be able to simultaneously view and interactively edit the graphics and/or text of the proposed newsletter as stored in the publisher's personal computer on their respective personal computers. Heretofore, the technology has not been available for even considering such a system on the personal computer level.

To be sure, remote information transfer has been possible for some time, including smoke signals, semaphore and telegraphy. In the computer context, however, data transfer has been predominantly one-way, and point-to-point. Similar to a water pipe, when the spigot is opened at the receiving end, a first computer can pump data in a one-way flow to a second computer. Later on, the second computer can reverse the process, and send data back to the first computer. As can be seen, however, it is almost always a start/stop discontinuous process and also point-to-point involving usually only two computers.

Recently, software has been introduced that permits the user to view the operations of a second computer and, in some cases, to even control that second computer if necessary. Such software has been useful in remote trouble-shooting and software diagnostics. In this case, data is transferred point-to-point between the two computers by conventional data transfer means, such as over a standard telephone line using modems at each location. While it is conceivable that such software could permit the user of a second personal computer at a remote location to view work being performed on a file by the user of first personal computer, drawbacks to this method of potential newsletter editing are several.

First, the method would normally only work with two users. The software is not designed to support a plurality of users at separate remote locations. Second, data transfer speed is slow, effectively inhibiting transmission of bit mapped graphics and color images. Third is that only one user at a time may edit a file. Fourth is that such software is commonly acknowledged to be slow, and especially ill-behaved with inevitable data collisions and data contamination unless operated according to strict and tedious protocols. The significance of these drawbacks is further discussed below.

It is a well-established principal in cognitive psychology that, in order to maintain perception, changes in stimulation are necessary. Accordingly, after initially reading a screen of data, if the non-active user at the remote second personal computer stares at a static screen for an extended period of time, he will lose perception. When relatively large amounts of data or updates are sent at once to the second or a third personal computer, the context of the new data will very likely be unclear to the non-active user who has lost perception, and it can take some time before the non-active user regains perception and realizes the context of the new data or updates. Further, using the available software packages, the non-active user of the second personal computer can only observe changes that have been made by the active user of the first personal computer. The non-active user is not able to access the first personal computer to edit the file while the active user is in control. In this regard, studies have shown that man's short-term memory is very fragile. In as few as nine seconds after a simple concept, such as a few words, has been presented, studies show that short-term memory becomes inaccurate in recalling the simple concept. After 30 seconds, short-term memory becomes very fragile. Even the slightest amount of interference after 30 seconds can destroy whatever thought is being held in short-term memory. Thus, any ideas the non-active user has for editing the file may easily be lost forever.

Low data transmission speeds also contribute to the limitations of the available software packages. Most modems in use with personal computers today operate at 300, 1200 or 2400 bits per second (bps) and are fully compatible. Faster modems, which operate at 4800, 9600 and 19,200 bps, are also available. However, these modems are less common and much more expensive. Also, as the Consultative Committee on International Telegraph and Telephone (CCITT) has yet to establish standards for all these speeds, the faster modems of the same speed are not all compatible. Further, sophisticated error correction and full duplex transmission are not available in some faster modems, and in some of the modems in which error correction is available, four-wire leased telephone lines are required, rather than the standard and much less expensive two-wire dial-up telephone lines.

Due to the low transmission speed, the available software packages for transferring text and graphics have very limited graphics and color capabilities. Graphics and color are data intensive. Sending graphics and/or color data over a 2400 bps modem takes a relatively large amount of time. However, graphics and color are important in newsletters and the like. They are powerful tools for attracting attention, assigning priority, coding information, adding redundancy, etc. If the non-active user is not able to see the graphics being provided and/or the colors being used, the non-active user is constrained as to the type of interaction that can take place.

Dedicated local area networks are now becoming available. These provide faster transmission speeds. However, these require dedicated lines, serve limited areas, and generally do not provide the flexibility and cost-effectiveness required by small publishers and their customers.

From the above, a cost-effective system which allows one or more remote users to see the newsletter on their own personal computers as it is intended to be published, to see changes almost in real time as they are being made, and to contemporaneously and interactively make changes as they see fit is clearly needed for effective editing of newsletters and the like.

### SUMMARY OF THE INVENTION

Accordingly, an object of the present invention is to provide an interactive editing system for a plurality of remotely located personal computers which allows substantially simultaneous real time editing of a document being edited by any of the personal computers at virtually any time.

Another object of the present invention is to provide a desktop publishing system for remote personal computers which permits changes to a file being edited to be seen by all users nearly immediately.

A further object of the present invention is to provide a low cost system which permits users of a plurality of personal computers to be able to edit and/or view editing of a single file resident in one of the personal computers in real time.

Yet another object of the present invention is to provide a flexible system by which a single file may be simultaneously accessed by a plurality of remotely located personal computers.

Still another object of the present invention is to provide an inexpensive real time interactive editing system for personal computers which allows interaction between remote users without loss of perception or new ideas due to slow transmission speeds and/or lack of immediate access to a file.

An additional object of the present invention is to provide a cost effective means for remote parties to effectively and quickly edit a document.

To achieve the foregoing objects and in accordance with the purpose of the invention, as embodied and broadly described herein, an interactive editing system for a plurality of users at respective remote locations for permitting any of the users to edit a file to be edited, comprises: a plurality of personal computers, one for each of the users, at least one of the personal computers using multi-tasking processing means, the personal computer using the multi-taking processing means coordinating editing by the users through their respective personal computers of the file to be edited; and interconnecting means for interconnecting the personal computers.

Preferably, the interactive editing system further comprises a plurality of voice communication means, one associated with each of the personal computers, for enabling voice communication between the users. The interconnecting means is preferably a non-dedicated digital communications system, and the personal computers communicate digitally over the non-dedicated digital communications system. The non-dedicated digital network can link both the personal computers and the voice communication means.

Alternatively, the interconnecting means may comprise a plurality of modems, one associated with each of the personal computers, and an analog communications link. In this case, each of the personal computers would preferably include data compression/decompression means so that data to be communicated between the personal computers is compressed before being sent over the analog communications link and decompressed when received from the analog communications link.

Additionally, the present invention provides for a system for substantially simultaneously editing a file by any of a plurality of users, comprising: a plurality of personal computers, one for each of the users, each of the personal computers including means for inputting and means for displaying; and interconnecting means for interconnecting the personal computers, wherein the personal computers include means for coordinating input to any of the input means so that the file can be substantially simultaneously edited from any of the personal computers.

Preferably, the coordinating means is linked to the input means and display means of each of the personal computers utilizing the interconnecting means, and the coordinating means sequentially polls the input from each of the input means, performs any requested operation on the file, and sends data indicative of the requested operation to all of the display means as the operation is carried out. The system may also comprise a plurality of voice communications means, one associated with each of the personal computers, for enabling voice communication between the users. The interconnecting means can be a non-dedicated digital communications system, so that the personal computers communicate digitally over the non-dedicated digital communications system. Similarly, when the interconnecting means is a non-dedicated digital network, the non-dedicated digital network can link both the personal computers and the voice communication means.

Alternatively, the interconnecting means may comprise means for converting digital signals to analog signals and analog signals to digital signals associated with each of the personal computers, and an analog communications link for connecting the converting means, wherein each of the personal computers includes data compression/decompression means so that data to be communicated between the personal computers is compressed before being sent over the analog communications link and decompressed when received from the analog communications link.

The personal computers can be grouped in a plurality of local area networks, and the interconnecting means may include network bridges and gateways for allowing communication between the personal computers on different ones of the local area networks.

Further, the coordinating means can lock out any of the users so that the input by a locked-out user will not be considered by the coordinating means.

The present invention also provides a method for substantially simultaneously editing a file from any of a plurality of personal computers situated at remote locations, at least one of which uses a multi-tasking operating system, comprising the steps of: interconnecting the personal computers over a communications link; and processing the file under control of the one of the personal computers using the multitasking operating system according to instructions input from any of the personal computers.

Preferably, prior to the interconnecting step, voice communications are established between users at each personal computer. Also, the personal computers can be interconnected and the telephone communications established over the same communications link.

Other objects and advantages of the present invention will be set forth in the description and drawings which follow, in which like reference numbers denote like parts, and, in part, will be obvious from the description, or may be learned by practice of the invention.

### BRIEF DESCRIPTION OF THE DRAWINGS

FIG. 1 is a general view of a plurality of personal computers having telephone handsets interconnected over a single digital communication link;

FIG. 2 is a detailed schematic view of the linkage of the personal computers illustrated in FIG. 1;

FIGS. 3A-3B show a flow chart of a method for the simultaneous editing of a single document by a plurality of users at respective remote personal computers according to the present invention;

FIG. 4 is a general view of a plurality of workstations which include personal computers and telephone handsets independently interconnected over analog communication lines;

FIG. 5 is a detailed schematic view of the linkage of the personal computers illustrated in FIG. 4; and

FIG. 6 is a flow chart of a method by which a remote personal computer interacts with a host personal computer to display and edit a file in the host personal computer when the communication link is analog.

### DESCRIPTION OF THE PREFERRED EMBODIMENT

For purposes of illustration and explanation only, three personal computers are illustrated and discussed. The system according to the present invention is designed to function for two or more remotely located personal computers.

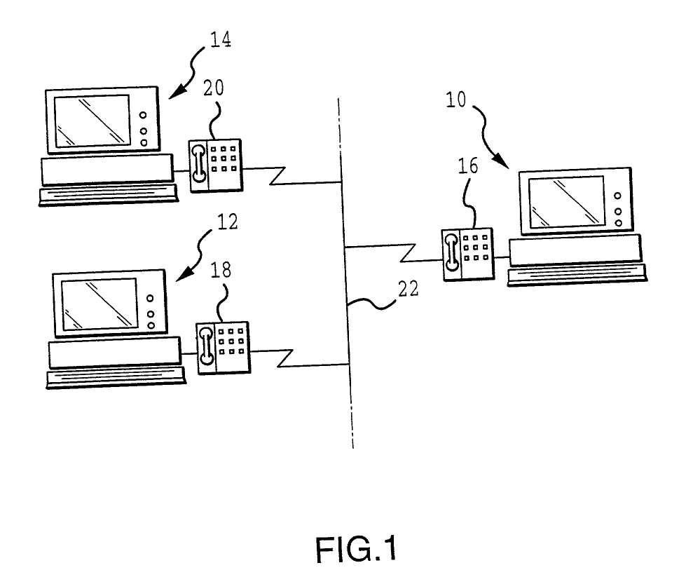

FIG. 1 illustrates three remotely located personal computers (PCs) 10, 12, 14. The PCs 10, 12, 14 can be located in different buildings in the same city, in entirely different cities or different countries. The PCs 10, 12, 14 are linked over a digital communications network 22. Associated with each of the PCs 10, 12, 14 are telephone handsets 16, 18, 20, respectively. The telephone handsets 16, 18, 20 are preferably digital telephones and are connected over the same line of the digital communications network 22 as are the PCs 10, 12, 14.

The PC's 10, 12, 14 can be in any type of configuration, such as in word processing workstations or engineering workstations, and can be independent or associated with different local area networks. If associated with different local area networks, bridges can be used to provide compatibility, if necessary.

Traditionally, a personal computer is defined as a single-user microcomputer designed for personally controllable applications. However, recently introduced single-user computers have many times the processing power of their predecessors, and the term personal computer covers a wide variety of products. Today, single-user personally controllable “desktop” computers are used in technical or engineering workstations for CAD/CAM and the like. Many of these personal computers use reduced instruction set computing (RISC) microprocessors, and can perform functions in a single-user system which were until only recently available just from mainframes. With the introduction of yet more powerful machines, the capabilities of personal computers will continue to evolve and expand.

A single file or document can be composed of words, graphics, other known computer representations or combinations thereof. In order to permit interactive editing of any portion of a file resident in a host PC by users of a plurality of PCs, at least the host PC, designated in FIG. 1 as the PC 10, must have capabilities which are only just now becoming available on the personal computer level. Preferably, the host PC 10 should have relatively fast processing capabilities and have multi-tasking capabilities. Multi-tasking can be implemented through the PC's microprocessor, operating system, the application software, the operating software, or some combination thereof. Fast processing speeds and multi-tasking are possible on personal computers which utilize complete instruction set computing (CISC) microprocessors, such as the Intel 80XXX series, including the 80386 and the recently introduced 80486 microprocessors, and also on CISC microprocessors such as the Motorola 86XXX series, including the 68030 and recently introduced 68040 microprocessors. These capabilities are also possible on reduced instruction set computing (RISC) microprocessors, which are produced and/or utilized by such companies as Sun, IBM, Hewlett-Packard and DEC.

For example, Intel's 80XXX microprocessors are being utilized by IBM in its PS/2 series of personal computers. The more advanced of the PS/2 personal computers also utilize IBM's Micro Channel architecture, which speeds up data transfer within the personal computer, and the recently introduced OS/2 operating system, which is a multi-tasking operating system. The heretofore standard operating systems for personal computers, such as MS/DOS and the MacIntosh operating system, are not capable of multi-tasking in and of themselves.

Software is also available that can effectively convert a single-tasking personal computer into a multi-tasking machine. In this way, a single-tasking personal computer is able to run a plurality of different tasks or programs simultaneously. Until recently, however, few presently available personal computers were powerful enough to perform effective multi-tasking through the use of software.

In summary, most presently available personal computers do not have the capabilities necessary for effective multi-tasking. However, availability will become less of a problem as the new faster personal computers presently being developed are introduced to the marketplace. At present, the fastest personal computers operate at only approximately two million instructions per second (MIPS). However, within a relatively short period of time, it is expected that personal computers will be widely available which operate at many times that speed.

As discussed above, the host PC 10 should be a relatively fast personal computer capable of multi-tasking. The remote PCs 12, 14, which can be located in entirely different cities from the host PC 10, are connected to the host PC 10 by the digital communications system 22. The remote PCs 12, 14 do not necessarily have to have all of the capabilities of the host PC 10. In the preferred embodiment, the remote PCs 12, 14 have a master/slave relationship with the host PC 10. More specifically, the peripherals of the remote PCs 12, 14, i.e. the keyboard, the display, and memory, are controlled by and communicate with the microprocessor of the host PC 10. The microprocessors in the remote PCs 12, 14 play supporting roles only.

As discussed above, in order for substantially real time editing of a single document by a plurality of personal computer users to become a reality, speed of communications and cost effectiveness are essential. Until recently, this was not possible. Private digital communications systems have been available for some time. These provide high speed communications, but require dedicated lines. Dedicated lines are generally not available at a cost which is affordable to small businesses and do not provide the flexibility necessary for communicating with customers spread out over the entire country. However, with the arrival of the integrated services digital network (ISDN), readily affordable high speed communications together with the necessary flexibility is becoming a reality. ISDN is a non-dedicated digital communications network which can carry voice and data over the same pair of standard telephone wires. Depending upon the configuration, ISDN can transmit data at speeds up to 64 kilobits per second (kbps), while at the same time permitting simultaneous voice communication over the same line. As ISDN operates on telephone lines already in place, virtually no special equipment is necessary, and thus capital outlay is minimal.

When fully operational nationally, once ISDN is in place for a user, high speed digital communications is possible with any other ISDN subscriber in the country. And when international standards are established and the equipment is in place, international communications between ISDN subscribers will be possible. The only hardware that is necessary to connect a personal computer to an ISDN interface line is an ISDN adapter, such as the ISDN Tel Adapter, which is available from Progressive Computing of Oakbrook, 111.

In addition, further engineering breakthroughs have been made which will enable even faster digital communications over non-dedicated lines. As these breakthroughs are implemented and become available, they will permit even faster digital communications between remote PCs.

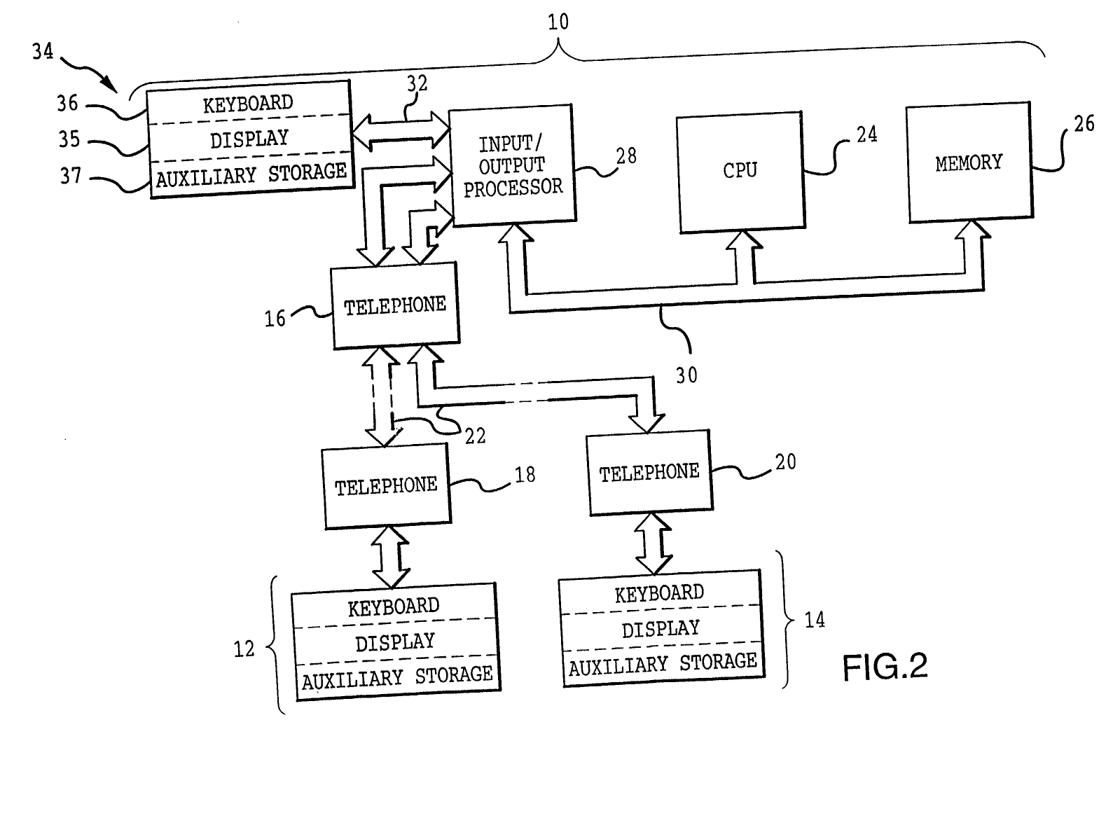

More features of the actual configuration of the system are illustrated in FIG. 2. The remote PCs 12, 14 need not be directly linked to each other over the digital communications network 22, but rather linked directly to the host PC 10 only. The host PC 10 is a personal computer having the capabilities described above. The host PC 10 comprises a CPU 24, usually in the form of a microprocessor, internal memory 26, input/output processor 28, a bus 30 for connecting the CPU 24, internal memory 26 and input/output processor 28, and peripherals 34 which are connected to the input/output processor 28 either by a hardwire connection 32 or some other conventional means, such as infrared transmitters and receivers. The peripherals 34 can include a display 35, a keyboard 36, and auxiliary storage 37, as generally illustrated in FIG. 2.

The remote PCs 12, 14 are also connected to the host PC 10, as is illustrated in FIG. 2. The remote PCs 12, 14 are connected to the input/output processor 28 of the host PC 10 via the digital communications network 22. The CPUs of the remote PCs 12, 14 support the overall operation of the system so that in effect the peripherals of the remote PCs 12, 14 are linked directly to the input/output processor 28 and are under the control of the host PC 10. By establishing such a link, the CPU 24 of the host PC 10 interacts with the peripherals of the remote PCs 12, 14 like it interacts with its own peripherals 34. Data input by a user of the remote PC 12 via its keyboard is input directly to the host PC 10 over the digital communications network 22. The CPU 24 then controls what is to appear on the display of the remote PC 12. Since the transfer of this data is conducted over the digital communications network 22, the likelihood is reduced that user of the remote PC 12 will even notice a time delay that would suggest that an operation has been carried out at the host PC 10 rather than the remote PC 12.

The telephone handsets 16, 18 and 20 associated with each of the PCs 10, 12, 14, respectively, are also linked over the digital communications network 22. As discussed above, it is preferred that the digital communication network 22 be capable of simultaneously handling both voice and data communications. The telephone handsets 16, 18, 20 should be connected over the digital communications network 22 so that each user is able to listen to and speak with all of the other users. Alternatively, if the digital communication network 22 does not have both voice and data capabilities, the telephone handsets 16, 18, 20 can be linked via a traditional conference call over other lines, such as standard analog telephone lines.

The preferred way to initialize the link-up between the PCs 10, 12, 14 is to first establish a conference telephone link between the users using the telephone handsets 16, 18, 20 over the digital communications network 22. Alternatively, a conference call may be established using standard telephone equipment and lines in the conventional way. Then, the PCs 10, 12, 14 are initialized and linked over the digital communications network 22.

In the preferred embodiment, the microprocessors of the remote PCs 12, 14 perform a supporting role only. The keyboard, display and memory of each of the remote PCs 12, 14 act as peripheral devices to the host PC 10.

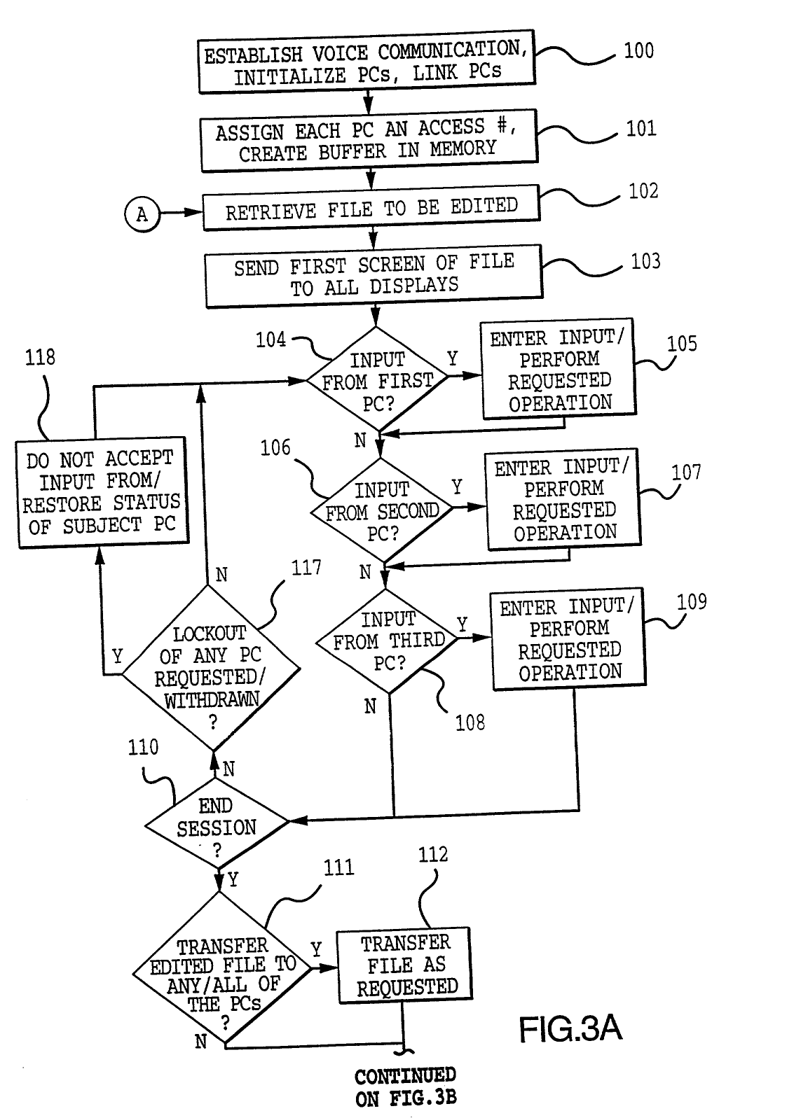

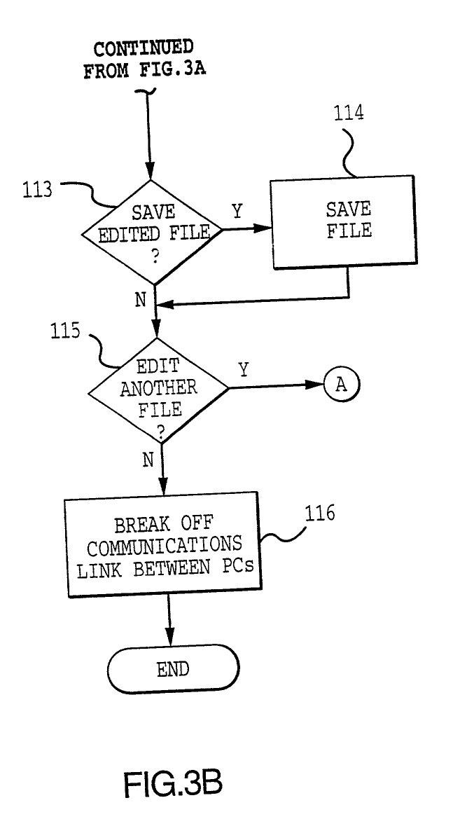

The flow chart of FIG. 3 illustrates the operation of the system as perceived by the host PC 10. In step 100, communication is established between the users, the PCs are initialized, and communication established between the PCs. The host PC then arbitrarily assigns each PC an access or designation number, and creates a buffer in its memory in which incoming data input or function requests may be stacked, if necessary, in step 101. In step 102, the host PC retrieves from any of the PCs the file to be edited, and performs any initial housekeeping procedures that must be carried out before actual editing may begin. At this time, all of the PCs are linked, and all of the users are in voice communication over the telephone handsets provided at each respective PC.

After the host PC retrieves a file for editing from the memory of any of the PCs, the first screen of the file is typically sent to each PC and displayed on the display of each PC (step 103). At this time, editing of the document by any of the users can begin. As illustrated in steps 104-109, the microprocessor of the host PC essentially sequentially polls each of the PCs for input. In the preferred embodiment, in step 104 the microprocessor polls the buffer which holds input for the first PC for input therefrom. The buffer may be checked for a certain period of time, until the buffer is empty, or until it is determined that no input data has been placed in the buffer, i.e. the user of the first PC has not input any data. If there is input, the microprocessor then enters the input and performs the requested function on the file image in memory being edited in step 105, and sends any updates of the file to the displays as they occur. The microprocessor then performs the same function for the other two PCs in steps 106-109. If no changes are requested in the polling sequence or the session is not to be ended, the polling is repeated, starting with step 104.

In general, since the time allotted for polling each PC is extremely small (in the milliseconds), no discernable delay in the processing will be perceived by the users, especially when the number of active users is relatively small. Given that word processing does not normally tax the capability of a typical microprocessor, having three users perform word processing functions on a single advanced microprocessor will not be substantially slower from the viewpoint of even the remote users. The high speed digital communication possible over the digital communications network 22 makes this possible. When editing changes the portion of the file being displayed, the changes are sent to all of the displays simultaneously, and due to the communications speed, a significant delay will not be perceived.

An example of a time that the microprocessor of the host PC may be relatively slow is when a rather complex function is requested, or when a large number of personal computers are active and may engage in editing. Such functions include merging files, moving blocks of data within a file, storing or printing a file, changing the margins or type, performing a spell check operation, etc. When such complex functions are requested, the microprocessor will temporarily stop its polling process, and work on the requested function until the function is completed. This prevents new data from being introduced to the file while the file is being stored, misspelled words from being input while a spell check operation is being performed, a file being changed while the file is being printed, etc. Depending on the function being performed, the microprocessor will either lock out the users from inputting any data or hold input in the buffers.

For the most part, the users will be interacting over the telephone while one user actually performs work on the file. In such cases, the non-active users do not even need to have access to the file. Rather, they can simply simultaneously watch the changes as they are made to the file and communicate their thoughts or ideas with the active user over the telephone hookup.

However, in some cases, different users may actually wish to work on different parts of the file. The user of the host PC may be editing page one of the file, while the user of one of the remote PCs may be editing page three of the file. In this situation, the need for multi-tasking can become important. The relative position of each user in the file must be maintained while different portions of the file are being edited. The microprocessor in this case must send screen updates to each user which are pertinent only to the portion of the file each user is editing. In order to maintain a first user's perception while a second user is changing the file, the first user's display may be only changed to conform to changes entered by the second user only periodically or at the first user's request. The relative position of each user can be maintained by keeping the relative address of each user at the bottom of a stack in the buffer, placed there when the microprocessor finishes polling of that user's PC, and read first when polling of that PC's buffer begins again.

After each polling sequence, the microprocessor checks to see if a request has been made to end the editing (step 110). If so, each PC is queried as to whether its user wants the edited file placed in its memory (step 111), and performs whatever transfer is requested (step 112). The host PC is then queried as to whether it wants to save the edited file (step 113), and if so, the file is saved (step 114). In step 115, the host PC is queried as to whether another file is to be edited. If so, that new file is retrieved in accordance with step 102, and interactive multi-user editing of the new file is begun. If not, communication between the PCs is broken off (step 116).

As noted above, the system may become slow when a large number of users have access to the file. In such cases, the polling of all the users would take a relatively large amount of time. However, it is likely that not all of the users would need access to the file. In order to increase the relative speed of the editing, any of the PCs may be locked out and made non-active. If such is requested for a particular PC, that PC's buffer will not be checked for input. The PC will continue to be able to view the editing that is taking place, and its user will be in telephone contact with the other users should he or she have any comments. Conversely, a locked-out PC may be restored to editing status at any time. The lock-out and restoration of status is carried out in steps 117 and 118.

In actual use of the present invention, a newsletter editor in Denver having the host PC would first establish a conference telephone call with customers in Kansas City and San Francisco. All three users would then initialize their respective PCs and establish a link between the PCs over ISDN. The Denver user would then retrieve a file to be edited and perform any housekeeping functions using the host PC. The microprocessor of the host PC would then send the first screen of the file to the display of each PC. It is envisioned that the three users would remain in communication over the telephone link, trading suggestions and comments back and forth, while one of the users actually edits the file, until agreement is reached that the file is in the desired condition. However, any of the users may edit the file at any time, unless that user has been specifically locked out. When the file is in the desired condition, the edited file can be stored by any of the PCs as necessary. The telephone and PC links would then be ended, or work on a new file to be edited begun.

It is also possible to implement the present invention without the polling function and the buffers. In this case, the file would be subject to the input of any user at any time. In such cases, interaction between the users over the telephone is imperative in order to prevent simultaneous input of data, which could result in data collisions and crashing of the system.

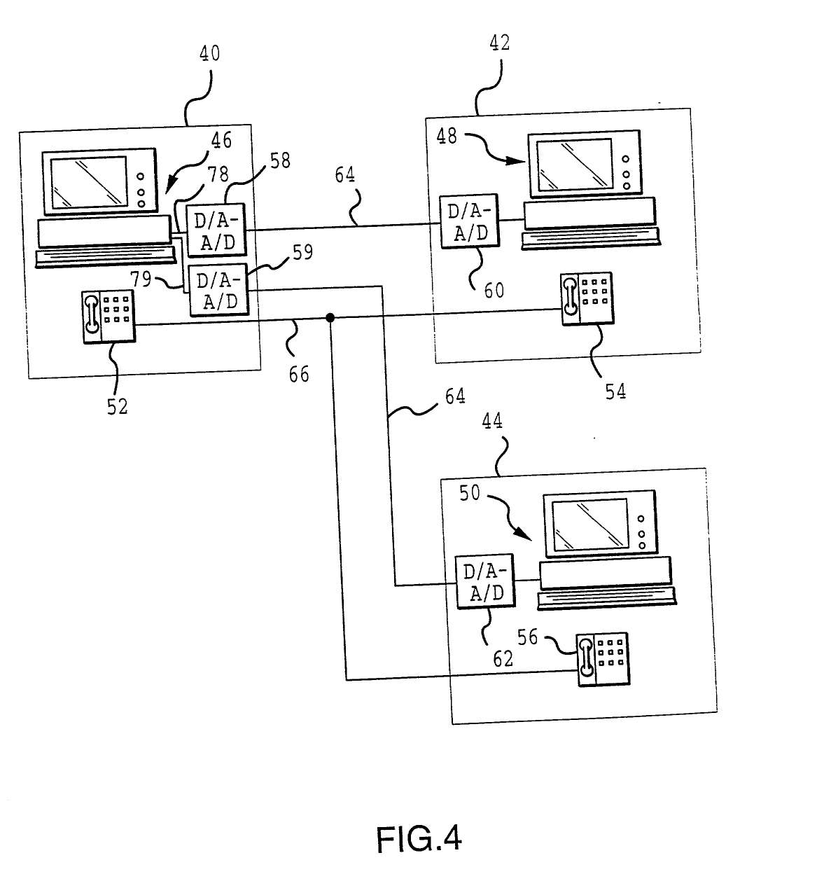

An alternative embodiment is illustrated in FIG. 4. FIG. 4 illustrates three workstations 40, 42, 44 comprising respective PCs 46, 48, 50, and telephone handsets 52, 54, 56. The workstation 40 is arbitrarily designated as the host workstation. The host workstation 40 includes a host PC 46 which has the capabilities discussed above. The host PC 46 is connected to remote PCs 48, 50 at the remote workstations 42, 44 over an analog communications network 64 via digital-to-analog/analog-to-digital converters 58, 59 (one for each remote workstation). Using this equipment, digital signals from the host PC 46 are converted to analog signals (modulated) for transmission over the analog communications network 64, and vice versa. Additionally, each remote workstation 42, 44 has a digital-to-analog/analog-to-digital converter 60, 62, respectively, for communicating with the host PC 46 via the analog communications network 64 and the respective host digital-to-analog/analog-to-digital converters 58, 59.

In order for the present invention to operate using modems and standard telephone communication lines, high-speed modems are necessary. Therefore, the digital-to-analog/analog-to-digital converters should be 9.6 kbps or faster modems which are compatible with each other. However, even at 9.6 kbps, data transfer may not be fast enough such that any change to the file will appear substantially simultaneously to all of the users. Therefore, each of the PCs 46, 48, 50 should use compression utilities and/or each of the modems should have data compression/decompression capabilities. Compression utilities are readily available, and can effectively compress data being sent. Using such compression utilities, 85 percent compression of data is possible. Actual effective throughput of data over the modems can be increased with compression utilities to as much as 100 kbps, rather than the sub-ten kbps without them. Alternatively, modems having inherent data compression/decompression capabilities that effectively increase throughput of data to well beyond 9.6 kbps are now becoming available that can be used for increased data transfer rates. Also, as long as data compression techniques and/or speeds are compatible, a combination of data compression/decompression capable modems and PCs which utilize data compression/decompression utilities can be used in a system.

In any case, in order to make the system fully operational, the digital-to-analog/analog-to-digital converters 58, 59, 60, 62 should be full duplex 9.6 kbps or faster modems. This permits high speed exchange of data back and forth between the remote PCs 48, 50 and the host PC 46.

Further, in the configuration illustrated in FIG. 4, the telephone handsets 52, 54, 56 are connected over a separate analog communication line 66. This is different than the preferred embodiment, in which voice and data communications are over the same line.

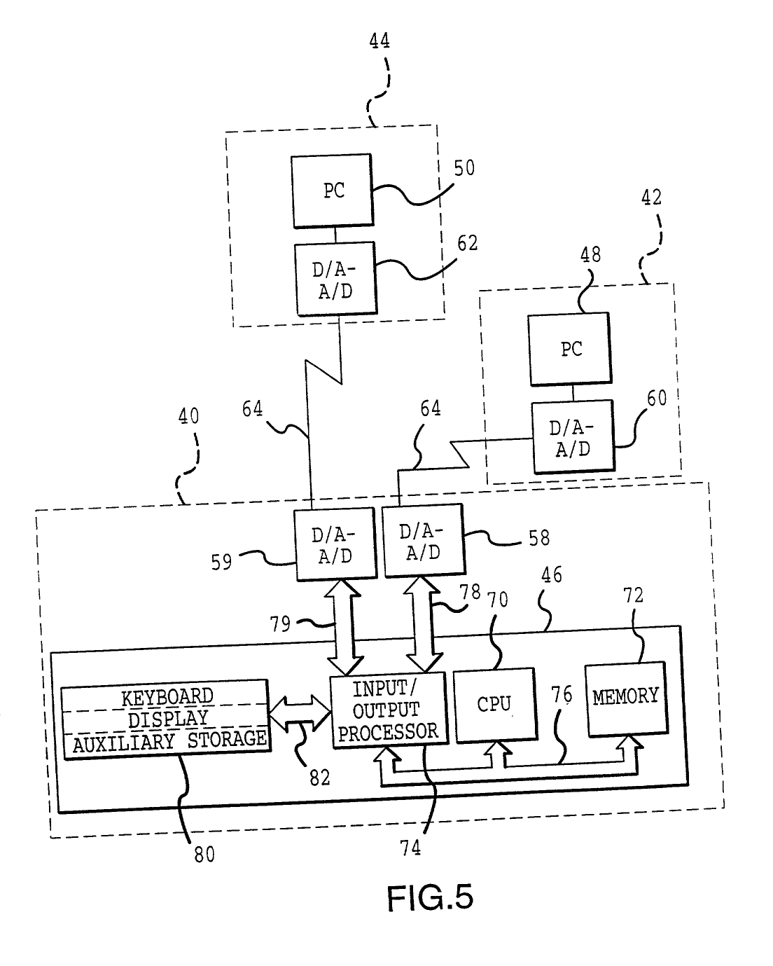

FIG. 5 illustrates the system configuration for an analog embodiment in which the PCs perform the data compression/decompression function. The host workstation 40 includes a PC 46 which comprises a CPU 70, memory 72, an input/output processor 74, and peripherals 80. The CPU 70, the memory 72, and the input/output processor 74 are interconnected by a bus 76. The input/output processor 74 is linked to the peripherals 80 by a hardwire connection 82. Also included in the workstation 40 are the digital-to-analog/analog-to-digital converters 58, 59, which are linked to the input/output processor 74 by hard wire connections 78, 79 respectively, or other suitable means. The digital-to-analog/analog-to-digital converters 58, 59 connect the workstation 40 to the digital-to-analog/analog-to-digital converters 60, 62 in the respective workstations 42, 44 over the analog communications network 64. The digital-to-analog/analog-to-digital converters 60, 62 are connected to their respective remote PCs 48, 50, each of which have a similar configuration to the host PC 46.

In FIGS. 4 and 5, the two separate lines 78, 79 are illustrated connecting the respective digital-to-analog/analog-to-digital converters 58, 59 to the host PC 46. When a large number of remote PCs are being used, the number of such lines actually being input into the host PC 46 can be reduced by using multiplexers to bring the input from a plurality of such analog lines into one or a few serial lines going into the host PC 46. This would reduce the workload of the host PC 46.

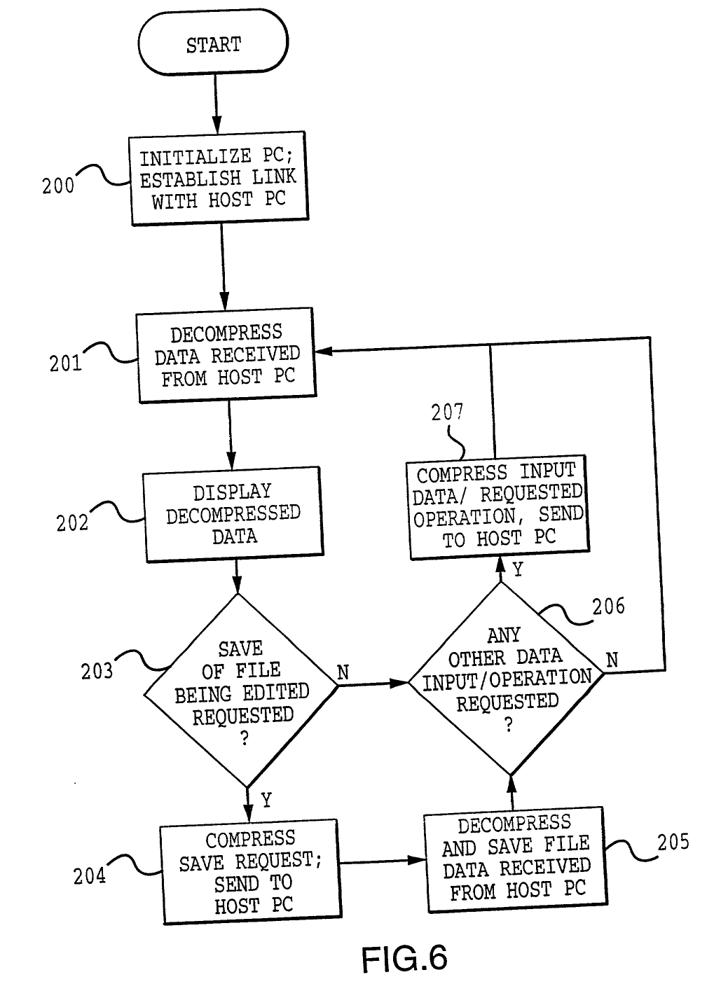

The actual operation of the present invention over an analog communications line is slightly different than the digital operation. The digital-to-analog/analog-to-digital converters 58, 59, 60, 62 and/or the PCs 46, 48, 50 must be capable of independent and compatible compression and decompression of data being sent and received. Further, the remote PCs 48, 50 will play a greater role in the analog system than in the preferred digital embodiment when the digital-to-analog/analog-to-digital converters do not handle data compression/decompression. This situation is illustrated in FIG. 6.

FIG. 6 is a flow chart of the operation required from the perspective of each of the remote PCs 48, 50 in this latter case. After the remote PC is initialized, communication is established over the digital-to-analog/analog-to-digital converters with the host PC (step 200). The remote PC then decompresses data received from the host PC (step 201), and displays the decompressed data on its display (step 202). If the remote user requests to save the file (step 203), the remote PC compresses the request and sends it to the host PC (step 204). When the file data is received, the remote PC then decompresses and stores it (step 205). Subsequent to this step or if no save is requested, the remote PC checks for input data or any other operation request from the remote user (step 206). If any is made, the data or operation request is compressed and forwarded to the host PC. If no such request is made, or after the data is sent, the remote PC decompresses data received from the host PC (step 201), thereby starting the process again.

The function of the host PC in the analog embodiment is similar to that as illustrated in the flow chart in FIG. 3 for the digital embodiment. However, either the host PC or its associated digital-to-analog/analog-to-digital converters should be capable of compressing data prior to sending it to the remote PCs and decompressing data when it is received from the remote PCs.

The present invention may also be carried out using a host PC, as discussed above, and remote computer terminals that do not have the full power of a PC. The remote terminals can be ASCII terminals if transmission of text only will be performed, or bit-mapped image terminals if text and graphics will be transmitted. Such terminals need only have enough local intelligence to enable communications with the host PC. Referring once again to FIGS. 1 and 2, the only difference between this embodiment and the preferred embodiment discussed previously with respect to FIGS. 1 and 2 is that elements 12 and 14 would be ASCII or bit-mapped image terminals rather than full-fledged PCs. Similarly, terminals of this type could be used in place of the PCs 48, 50 in FIGS. 4 and 5 in an analog embodiment. In this case, the digital-to-analog/analog-to-digital converters 60, 62 should be capable of data compression and decompression, as the minimal processing power of the remote terminals would most likely not be able to support this function.

While several embodiments of the invention have been discussed, it will be appreciated by those skilled in the art that various modifications and variations are possible without departing from the spirit and scope of the invention. For example, as the processing power of PCs increases and communications systems improve further, it will be possible to implement the present invention so that processing of a file can be performed substantially contemporaneously by a plurality of the PCs. This would speed up the response of the system and would be particularly effective when a large number of users or time consuming processing is contemplated. No true host PC would be necessary, and each PC may only need to be in direct communication with one or two other PCs, as the system could function serially through a string of PCs or in a closed loop.

I claim:

1. An apparatus, comprising:
a processor; and
a plurality of ports, connected to the processor, for receiving inputs and providing outputs;
whereupon receiving an input which includes an edit for a file, the processor executes the edit and outputs, via the plurality of ports, an update for the file such that at least one of a plurality of user devices can receive the update substantially contemporaneously with the execution of the edit.

2. The apparatus of claim 1, wherein the apparatus further comprises a host computer.

3. The apparatus of claim 2, wherein the plurality of ports are connected to a communications network connecting the host computer with a plurality of user devices.

4. The apparatus of claim 3, wherein the communications network is an analog network and the ports include an interface between the analog network and at least one signal provided by the processor.

5. The apparatus of claim 4, wherein the interface further comprises a modem.

6. The apparatus of claim 3, wherein the communications network further comprises a digital network.

7. The apparatus of claim 1, wherein the processor is capable of multi-tasking.

8. The apparatus of claim 1, wherein the apparatus functions as a server for a communications network which can establish a connection between the apparatus and at least one user device.

9. The apparatus of claim 1, wherein the file includes a computer representation.

10. The apparatus of claim 9, wherein the computer representation includes computer graphics.

11. The apparatus of claim 9, wherein the computer representation includes text.

12. The apparatus of claim 1, wherein the edit further comprises an editing instruction.

13. An apparatus, comprising:
a processor;
a plurality of ports, connected to the processor, for receiving inputs from at least one user device and providing outputs to at least one other user device; and
an application program running on the processor;
whereupon receiving an input, from a user device, which includes an edit for a file, the application program executes the edit and outputs, via the plurality of ports, an update for the file such that the at least one other user device can receive the update substantially contemporaneously with the execution of the edit.

14. The apparatus of claim 13, wherein the processor is capable of multitasking.

15. The apparatus of claim 13, wherein at least one of the application program and the file can be obtained from a data storage device accessible by the processor.

16. The apparatus of claim 15, wherein the data storage device is a local to the apparatus.

17. The apparatus of claim 15, wherein the data storage device is remote to the apparatus.

18. The apparatus of claim 13, wherein the application program is non-persistent.

19. The apparatus of claim 13, wherein the plurality of ports are connected to an interconnecting means.

20. The apparatus of claim 19, wherein the interconnecting means further comprises:
an analog communications network;
a first modem, for connecting the at least one user device to the analog communications network; and
a second modem, for connecting at least one of the plurality of ports to the analog communications network.

21. The apparatus of claim 20, wherein the second modem is connected to the at least one of a plurality of ports via a digital communications network.

22. The apparatus of claim 1, wherein the interconnecting means further comprises a digital communications network.

23. The apparatus of claim 22, wherein the digital communications network includes a local area network.

24. The apparatus of claim 23, wherein the digital communications network interconnects at least two local area networks.

25. The apparatus of claim 24, wherein the digital communications network includes a hub interconnecting at least one of the at least two local area networks with a second network.

26. The apparatus of claim 24, wherein at least one of the two local area networks include a switch.

27. The apparatus of claim 24, wherein the at least two local area networks are interconnected via a bridge.

28. The apparatus of claim 24, wherein the at least two local area networks are interconnected via a gateway.

29. The apparatus of claim 24, wherein the at least two local area networks are interconnected via a router.

30. The system of claim 13, wherein the file includes computer graphics.

31. The system of claim 13, wherein the file includes alphanumeric characters.
